(19) United States
(12) Patent Application Publication
(10) Pub. No.: US 2008/0129107 A1
(43) Pub. Date: Jun. 5, 2008

(54) Motor-Bearing Wheel Hub

(76) Inventor: Keith Hodgson, Santa Cruz, CA (US)

Correspondence Address: CENTRAL COAST PATENT AGENCY, INC, 3 HANGAR WAY SUITE D, WATSONVILLE, CA, 95076, US

(21) Appl. No.: 11/948,087

(22) Filed: Nov. 30, 2007

Related U.S. Application Data
(60) Provisional application No. 60/872,093, filed on Dec. 1, 2006.

(51) Int. Cl. B60B 27/04

(52) U.S. Cl. 301/110.5

(57) ABSTRACT

A motor-bearing wheel hub has a wheel hub open and flanged on one end, the hub including a wall opposite the open end with an opening therethrough at a central location for receiving a stator of an electric motor, the hub having interfaces for attaching to spokes of a rear wheel of a bicycle, an adaptor plate removably affixed to the flange, and an electric motor including a stator, windings, and a rotor, installed in the hub, with the stator, extending through central openings in the end wall and the adaptor plate, to be joined to a rear wheel fork of the bicycle. The hub is characterized in that the rotor is affixed to either the adapter plate inside the hub or to the inside of the hub.

The present invention claims priority to a U.S. provisional patent application Ser. No. 60/872,093 entitled “Aftermarket Electrical Bicycle Parts and Kits” filed on Dec. 1, 2006, disclosure of which is incorporated herein by reference.

### BACKGROUND OF THE INVENTION

1. Field of the Invention

The present invention is in the field of motorized bicycles and aftermarket parts and assemblies for adapting manually powered bicycles for motorized propulsion.

2. Discussion of the State of the Art

In the field of motorized bicycles there are bicycles that may be powered by direct current (DC) electrical motors. In some of these products, the motor is mounted somewhere on the bicycle frame and adapted into the normal hub and sprocket assembly by a drive mechanism and chain. The inventor is aware also of bicycles that have electric motorized wheel hubs that provide power to the rear wheel of such bicycles. These motorized hubs are mainly proprietary in nature and are not adaptable to a wide array of manually powered bicycles to adapt them for electric propulsion. Rather, they are manufactured only for specific bicycles to be outfitted and sold as motorized bicycles.

What is clearly needed is an aftermarket product including an improved motor-bearing wheel hub assembly for adapting a wider variety of manually pedaled bicycles for electric locomotion.

### SUMMARY OF THE INVENTION

In an embodiment of the present invention a motor-bearing wheel hub is provided, comprising a wheel hub open and flanged on one end, the hub including a wall opposite the open end with an opening therethrough at a central location for receiving a stator of an electric motor, the hub having interfaces for attaching to spokes of a rear wheel of a bicycle, an adaptor plate removably affixed to the flange, and an electric motor including a stator, windings, and a rotor, installed in the hub, with the stator, extending through central openings in the end wall and the adaptor plate, to be joined to a rear wheel fork of the bicycle. The hub is characterized in that the rotor is affixed to either the adapter plate inside the hub or to the inside of the hub.

In one embodiment the rotor of the electric motor is affixed to the adapter plate, such that the motor and plate may be installed and removed as a subassembly. Also in one embodiment the hub further comprises an interface on the adapter plate for affixing a sprocket assembly. In a variation of that embodiment there is a splined adapter removably affixed to the adapter plate over the stator, for accepting a splined sprocket assembly.

In another aspect of the invention a kit for adapting a bicycle for electric propulsion is provided, comprising a wheel hub open and flanged on one end, the hub including a wall opposite the open end with an opening therethrough at a central location for receiving a stator of an electric motor, the hub having interfaces for attaching to spokes of a rear wheel of a bicycle, an adaptor plate removably affixed to the flange, an electric motor including a stator, windings, and a rotor, installed in the hub, with the stator, extending through central openings in the end wall and the adaptor plate, to be joined to a rear wheel fork of the bicycle, the rotor affixed to either the adapter plate inside the hub or to the inside of the hub, a sprocket assembly, a battery back, a switch for powering the motor on and off, and an electrical line for connecting the battery pack and switch to the motor.

### BRIEF DESCRIPTION OF THE DRAWING FIGURES

FIG. 1 is a side view of a wheel-hub rim component according to an embodiment of the present invention.

FIG. 2 is a front view of the rim component of FIG. 1.

FIG. 3 is a perspective view of the rim component of FIGS. 1 and 2 laced into the spokes of a bicycle wheel.

FIG. 4 is a block diagram illustrating a motor-bearing wheel hub and sprocket assembly according to an embodiment of the present invention.

FIG. 5 is a block diagram of a motor-bearing wheel hub and sprocket assembly according to another embodiment of the present invention.

FIG. 6 is a process flow chart illustrating steps for adapting a manually pedaled bicycle wheel for electric propulsion according to aspects of the present invention

### DETAILED DESCRIPTION

The inventor provides an improved motor-bearing wheel hub and adaptive assemblies that can be incorporated with other electric motor parts and accessories for outfitting a wide variety of bicycles for electric propulsion.

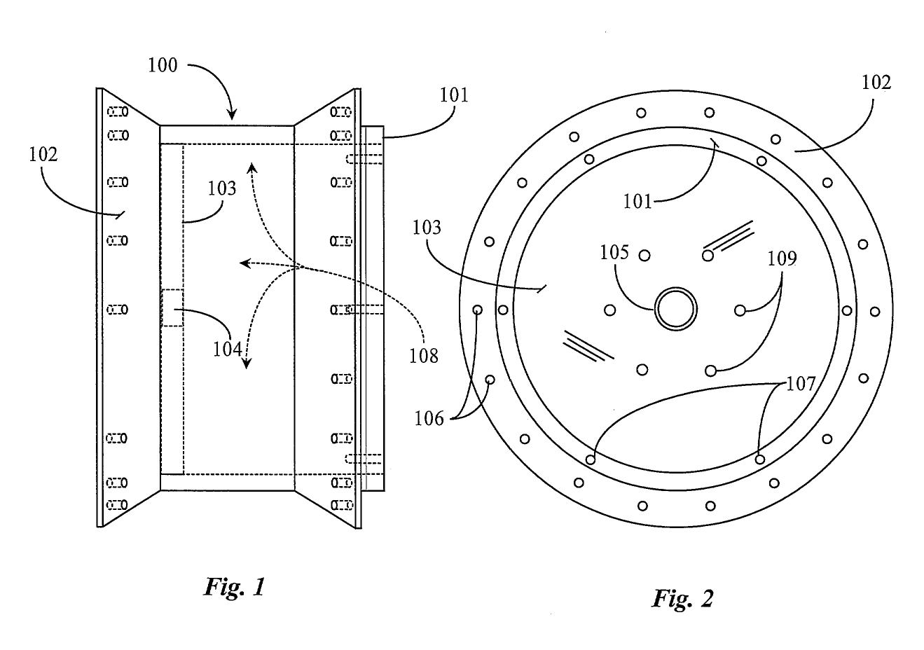

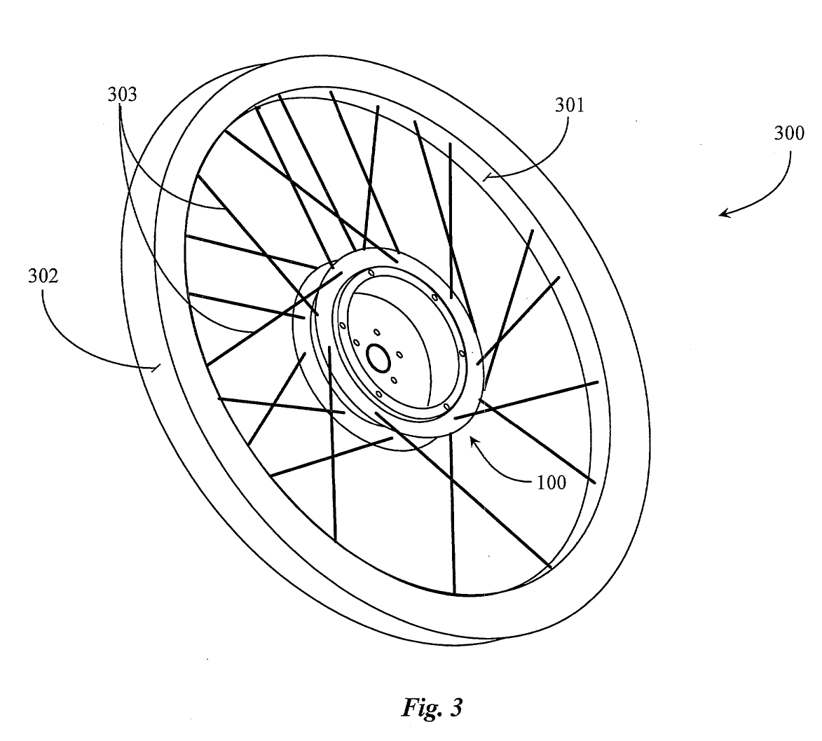

FIG. 1 is a side view of a wheel hub 100 according to an embodiment of the present invention. FIG. 2 is a front view of hub 100 of FIG. 1. Referring now to FIG. 1, wheel hub rim component 100 is provided in the general geometric construction of a rim body having flared ends 102 and hereafter will be referred to as rim 100. Rim 100 has a rear rim wall 103 disposed vertically from horizontal near one end of the rim. Rim wall 103 has an opening 104 provided therethrough substantially at the center of the wall. Opening 104 has an inside diameter of a size adapted to receive a stator shaft of a wound direct current (DC) electric motor. Stator shaft 104 is also referred to herein as stator 104.

Rim 100 may be formed of aluminum, steel, or other workable metals and may be produced, for example by working metal on a lathe. In one embodiment, rim 100 may be manufactured of a rigid and durable polymer and may be turned by lathe or may be injection molded in some cases. Rim 100 is open on the end opposite rim wall 103 and has sufficient open space 108 therein to facilitate insertion of a wound electric motor.

Rim 104 includes flared ends 102 at distal ends of the rim body, which generally flare out at some angle from the diameter of the rim body 100. The amount of angle of flare may vary according to design, however 30 degrees is representative of a common angle that may be sufficient. The ends are flared at both ends of rim 100 and, in a preferred embodiment the flared ends are contiguous to rim body 100 as is wall 103.

Referring to FIG. 2, opening 104 may be adapted by size to accept an annular bearing, such as a ball bearing or a bushing 105 of a specific inside diameter through which a stator shaft of an electric motor may be inserted with specificity to the diameter being just larger than the outside diameter of the stator. Flared ends 102 include a plurality of openings 106 provided through the angled walls thereof in an equally spaced and symmetrical bolt pattern. Openings 106 are adapted to receive the spokes of a bicycle wheel. In this way, rim 100 is adapted to be laced into the bicycle spokes of a bicycle wheel, perhaps replacing a wheel hub assembly and axel originally installed.

Referring again to FIG. 1, rim 100 has a flange 101 provided thereon and located at the distal end of the rim relative to the end proximal to wall 103. Flange 101 may also be contiguously formed with rim 100 and may be an extension of the central rim's body. It is important to note herein that there may be several variations to exact design of rim component 100 without departing from the spirit and scope of the present invention. The illustrated design is just a general example of several possible options.

Referring again to FIG. 2, flange 101 has a plurality of blind openings 107 arrayed in a bolt circle on the face of the flange. Openings 107, in one embodiment, are each internally threaded to a specific depth to adapt them for receiving screws or bolts of a specific length. In one embodiment, a DC motor and an adaptor plate (not illustrated here) may be secured to flange 101 by screws or bolts. In one embodiment, wall 103 of rim 100 further includes a plurality of through openings 109 arraigned in a bolt circle or pattern. Openings 109, if provided may be adapted for bolting the rotor of a DC wound motor directly to wall 103. More detail about assembly of a motor and adaptor plate to rim component 100 is provided below.

FIG. 3 is a perspective view of rim component 100 of FIGS. 1 and 2 laced into the spokes of a bicycle wheel 300. Bicycle wheel 300 includes a bicycle wheel rim 301 and a bicycle tire 302 in this example. In this embodiment, rim component 100 may be installed sans motor or other components to wheel 300 by “lacing” the rim to spokes 303 of the wheel. In this aspect, rim component 100 is modular and can be installed to virtually any bicycle wheel. It is noted that rim component 100 may be laced into wheel 300 with motor and adaptor plate installed as well. Further, in some cases the wheel may have a solid disc or discs instead of spokes.

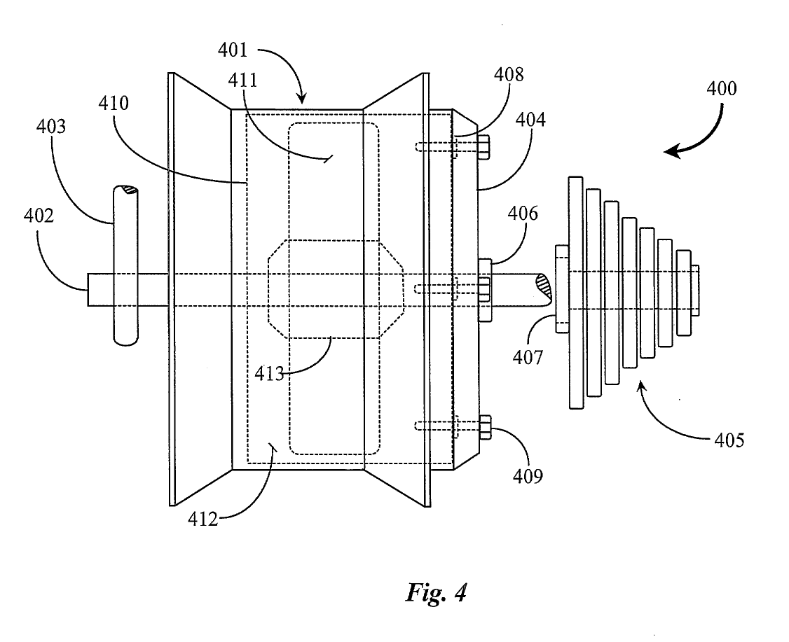

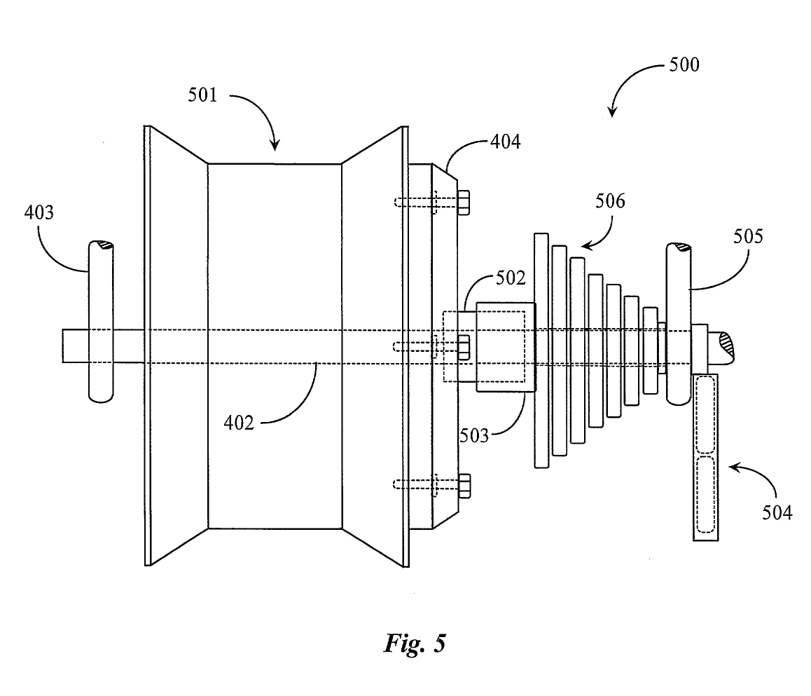

FIG. 4 is a block diagram illustrating a motor-bearing wheel hub and sprocket assembly 400 according to an embodiment of the present invention. FIG. 5 is a block diagram of a motor-bearing wheel hub and sprocket assembly 500 according to another embodiment of the present invention.

Referring now to FIG. 4, assembly 400 includes a completely assembled motor-bearing wheel hub 401 and a sprocket assembly 405. Wheel hub 401 includes a DC motor having a stator 402, a rotor 413, motor windings 411, and a rotor housing 412 (components illustrated by broken line). In this example, stator 402 is illustrated as fixed for illustrative purposes to a bicycle frame fork mount 403. Rotor 413 is rotatable about stator 402 and is fixed to motor windings 411. Rotor 413 is also fixed to rotor housing 412. Stator 402 is fixed and does not turn so when power is supplied to the motor, the motor turns around the fixed stator.

In this embodiment, rotor housing 412 has a plurality (two or more) of mounting tabs 408 provided at the end of the housing that is proximal to flange 101 of the rim body of the hub. Mounting tabs 408 extend outwardly substantially perpendicular form the peripheral edge of housing 412 and may be symmetrically located such as on 180 degree points (2 tabs), 120 degree points (3 tabs) or perhaps on 90 degree points (4 tabs). More than 4 tabs may be provided such as 5 tabs (72 degree points) or 6 tabs (60 degree points).

The electric motor may be installed within hub 401 by positioning tabs 408 with the stator extending through the stator opening in the rear wall of the rim component over openings (106) in flange 101 and then installing an adapter plate 404 to the flange over the rotor housing tabs. Adaptor plate 404 may be made of aluminum, steel, or some other rigid or semi-rigid material. Adapter plate 404 is adapted with openings that line up with openings 107 in the bolt circle of flange 101. Adapter plate 404 fits onto the assembly over stator 406 and has a through opening like opening 104 of FIG. 1 provided at substantially center adapted to accommodate stator 402 opposite the walled end of the rim component of wheel hub assembly 400. The stator is the hub axel of the assembly.

Adaptor plate 404 is screwed or bolted onto flange 101 over rotor housing tabs 408 the secure the assembly. In this case, the motor is not directly bolted or mounted to the rim component of the wheel hub, but to the flange of the rim component. Adapter plate 404 has an adaptive feature 406 provided in or about the central opening by machining. This adaptive feature may be a raised feature or a grooved feature containing some physical design adapted for coupling with a mating feature normally provided on a sprocket assembly 405. Sprocket assembly 405 fits over stator 401 and onto the adaptive feature 406 of adaptor plate 404.

Adapter plate 404, more specifically feature 406, is provided to enable wheel hub 401 to be combined with a variety of stock sprocket assemblies of varying number of “speeds” having the mating feature for engaging adapter plate 404. Engaging sprocket assembly 405 directly to hub 401 via adaptor plate 404 and adaptive feature 406 enables a user to pedal the bicycle forward in a manual. When sprocket 405 is not manually pedaled, it is a free-wheeling sprocket assembly such as is common for most multiple-speed assemblies. A standard derailleur system and chain can be leveraged to change speeds of sprocket assembly 405 as is generally known in the art.

In this example, sprocket assemblies having different speeds and from different manufacturers can be swapped with assembly 405. For example, assembly 405 (7-speed) can be replaced with a 9-speed or other sprocket. Adapter plate 404 can be removed to access the DC motor for maintenance purposes. Specifically in this example, the motor is secured to the wheel hub flange by the adapter plate thus providing for turning the wheel under power from the electric motor. In some other embodiments the motor may be secured to adapter plate 404, accomplishing the same purpose, but providing additionally a plate and motor assembly, which may be also complete with a sprocket assembly, all of which may be assembled to a rim by securing the bolts between the adapter plate and the flange of the rim.

Referring now to FIG. 5, in one embodiment, a standard splined adaptor 502 such as a Shimano™ adapter may be provided as an accessory that may be affixed to adaptor plate 404 bolted to the flange of hub housing 501. In this case, a sprocket assembly 506 having a base 503 with splined openings conformal to adaptor 502 may be provided to engage the adaptor plate. In this case, the adaptor enables adaptation to aftermarket sprocket assemblies having the correct splined opening that conforms to the particular adaptor. In one embodiment, the splined adapter is conformal on one side to the machined adaptive feature on adapter plate 404 such that splined adaptor 502 may be installed and removed depending on the sprocket assembly desired to be added to the installation.

In this embodiment and in the embodiment of FIG. 4, a variety of sprocket assemblies may be integrated into the installation. Stator 402 is secured to the frame fork mounts of the bicycle frame mount 403 and an opposing mount illustrated in FIG. 5 as fork mount 505. In both examples of FIG. 4 and FIG. 5, a standard rear derailleur mechanism can be used to change gears or “speeds” of adapted sprocket assemblies, which are free-wheeling assemblies when not pedaled. Derailleur mechanism 504 is logically illustrated in FIG. 5 (chain not illustrated). Removable adaptor plate 104 enables access to the electric motor for maintenance purposes or for swapping out motors having different reduction capabilities.

It is noted herein that the motor may be additionally or alternatively secured within the rim components of the wheel hub assembly by bolting the rotor housing to rear wall 103 through openings 109 using screws or bolts from the outside of the hub. In still another embodiment the motor may be secured by the rotor housing to the inside peripheral rim of the adapter plate before securing the adapter plate to the rim flange. In the latter embodiment, the motor may be removed and reinstalled to the hub with the adaptor plate in two steps of removing the stator from the fork mounts and removing the adaptor plate with motor.

In one embodiment of the present invention, the various components described in the examples illustrated can be provided as part of an aftermarket tool kit for converting a pedal assisted bicycle into an electric powered bicycle. Such a tool kit may include but shall not be limited to a wheel hub including an electric motor and adapter plate, a splined adapter, a battery pack, a handlebar switch, and the power line connecting the battery pack and switch to the motor. In one embodiment, the aftermarket kit may include a rear bicycle wheel with the complete motor-bearing hub already installed.

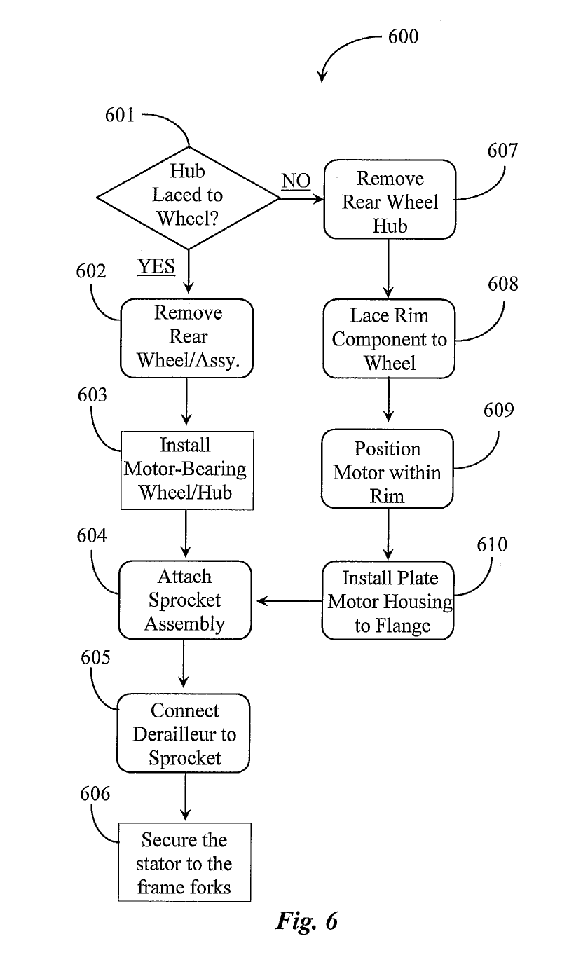

FIG. 6 is a process flow chart illustrating steps 600 for adapting a manually-pedaled bicycle for optional electric propulsion according to aspects of the present invention. At step 601, it is determined whether the motor-bearing wheel hub is already laced to the wheel of the bicycle. If it is, then at step 602 a user removes the original wheel from the bicycle and in step 603 installs the new wheel with the motor bearing hub.

At step 604, the user installs the sprocket assembly to the adapter plate over the stator of the motor. The stator serves the function of the wheel hub axel. At step 606, the user connects the derailleur mechanism and chain to the sprocket assembly. At step 606, the user secures (tightens) the motor stator to the bicycle frame forks. The stator does not rotate; rather the motor rotates about the stator providing a turning motion under power to the wheel hub.

In one aspect, if at step 606 the hub is not laced to a rear bicycle wheel provided as part of a kit, then at step 607, the user removes the rear wheel and removes the wheel hub from the rim and spokes of the wheel. At step 608, the user laces the rim component

It will be apparent to one with skill in the art that the motor-bearing wheel hub assembly of the invention may be provided using some or all of the mentioned features and components without departing from the spirit and scope of the present invention. It will also be apparent to the skilled artisan that the embodiments described above are specific examples of a single invention which may have greater scope than any of the specific descriptions taught. There may be many alterations made in the descriptions without departing from the spirit and scope of the present invention.

What is claimed is:

1. A motor-bearing wheel hub comprising:
a wheel hub open and flanged on one end, the hub including a wall opposite the open end with an opening therethrough at a central location for receiving a stator of an electric motor, the hub having interfaces for attaching to spokes of a rear wheel of a bicycle;
an adaptor plate removably affixed to the flange; and
an electric motor including a stator, windings, and a rotor, installed in the hub, with the stator, extending through central openings in the end wall and the adaptor plate, to be joined to a rear wheel fork of the bicycle;
characterized in that the rotor is affixed to either the adapter plate inside the hub or to the inside of the hub.

2. The wheel hub of claim 1 wherein the rotor of the electric motor is affixed to the adapter plate, such that the motor and plate may be installed and removed as a subassembly.

3. The wheel hub of claim 1 further comprising an interface on the adapter plate for affixing a sprocket assembly.

4. The wheel hub of claim 1 further comprising a splined adapter removably affixed to the adapter plate over the stator, for accepting a splined sprocket assembly.

5. A kit for adapting a bicycle for electric propulsion comprising:
a wheel hub open and flanged on one end, the hub including a wall opposite the open end with an opening therethrough at a central location for receiving a stator of an electric motor, the hub having interfaces for attaching to spokes of a rear wheel of a bicycle;
an adaptor plate removably affixed to the flange; and
an electric motor including a stator, windings, and a rotor, installed in the hub, with the stator, extending through central openings in the end wall and the adaptor plate, to be joined to a rear wheel fork of the bicycle, the rotor affixed to either the adapter plate inside the hub or to the inside of the hub.
a sprocket assembly;
a battery back;
a switch for powering the motor on and off; and
an electrical line for connecting the battery pack and switch to the motor.
